(19) United States
(12) Patent Application Publication
(10) Pub. No.: US 2026/0040387 A1
(43) Pub. Date: Feb. 5, 2026

(54) Use of Binding Indication Between Network Functions for Sharing Resource Redundancy Information Concerning Network Function Service Instances

(71) Applicant: Telefonaktiebolaget LM Ericsson (publ), Stockholm (SE)

(72) Inventors: Yunjie Lu, Shanghai (CN); Yong Yang, Kållered (SE); Chunbo Wang, Shanghai (CN)

(21) Appl. No.: 18/995,379

(22) PCT Filed: Jul. 13, 2023
(86) PCT No.: PCT/CN2023/107130

§ 371 Date: Jan. 16, 2025

(30) Foreign Application Priority Data
Jul. 19, 2022 (WO) PCT/CN2022/106496

(51) Int. Cl. H04W 76/20; H04L 67/02; H04W 60/04

(52) U.S. Cl. CPC H04W 76/20; H04L 67/02; H04W 60/04

(57) ABSTRACT

The embodiments herein relate to populating the information related to redundancy. In some embodiments, there proposes a method (400) performed by a first network function (201). The method (400) may comprise the step of transmitting (S401), to a second network function (202), a first message including a first parameter indicating no-redundancy to indicate that a first context is exclusively bound to a specific Network Function (NF) service instance within the first network function (201). The specific NF service instance may be identified in a binding indication included in the first message. The embodiments herein may allow the NF service instance to indicate the resource is exclusively bound to this NF service instance, there is no redundancy for the concerning resource.

### CROSS REFERENCE TO RELATED APPLICATION

This application claims priority of PCT Application Serial Number PCT/CN2022/106496 filed on Jul. 19, 2022 with title of “POPULATING THE INFORMATION RELATED TO REDUNDANCY”, the entire contents of which are incorporated herein by reference.

### TECHNICAL FIELD

The embodiments herein relate generally to the field of mobile communication, and more particularly, the embodiments herein relate to populating the information related to redundancy.

### BACKGROUND

The third Generation Partnership Project (3GPP) from Release 16 (Rel-16) has specified the concept of Network Function (NF) Set to allow service continuation among NF instances within the same NF set. To ensure optimized data replication management, the NF producer may indicate the preferred scope of data replication to the peer NF via binding indication.

3GPP TS29.500 Section 6.12.1 specifies that “Binding Indications shall not be used if a particular resource can only be served by a specific NF service instance of an NF instance, i.e. if NF service instances of a same NF service are not capable to share resource inside the NF Instance. A resource for which no Binding Indication or Routing Binding Indication is signalled shall be considered to be bound exclusively to one NF service instance, unless the NF Service resource owner instance is part of an NF set (or AMF set) or an NF service set, or unless its NF profile in the NRF indicates that its supports NF service persistence within the NF instance (see clause 6.5 of 3GPP TS 23.527 [38])”.

### SUMMARY

As specified in TS29.500, it is not possible to use binding indication to indicate, for example, that the resource is exclusively bound to a specific NF service instance, which may be a problem for some use cases.

The embodiments herein propose methods, network functions, computer readable mediums and computer program products for populating no-redundancy.

In some embodiments, there proposes a method performed by a first network function. The method may comprise the step of transmitting, to a second network function, a first message including a first parameter indicating no-redundancy to indicate that a first context is exclusively bound to a specific NF service instance within the first network function. The specific service instance may be identified in a binding indication included in the first message.

In an embodiment, the first message may further include a second parameter indicating a validation timer. The validation timer may indicate the validation period of no-redundancy.

In an embodiment, the validation timer may be included in the binding indication or another Hyper Text Transfer Protocol (HTTP) header.

In an embodiment, the first network function may be a NF service producer, and the second network function may be a NF service consumer. In addition, the first context may be a resource context; and the first message may be a response message or a notification message.

In an embodiment, the first network function may be a NF service consumer, and the second network function may be a NF service producer. In addition, the first context may be a session context or a resource context; and the first message may be a request message or a subscription message.

In an embodiment, the first network function may act as home Session Management Function (SMF) for a Home-Routed Packet Data Unit (PDU) session, and the respective visit SMF for the Home-Routed PDU session does not support redundancy.

In an embodiment, the first network function may be taken out of a set of NFs, due to service software upgrade, downgrade, or maintenance.

In an embodiment, the first network function may temporarily lose a connection towards an Unstructured Data Storage Function (UDSF), which is shared by a set of NFs.

In an embodiment, the method may further comprise the step of receiving, from the second network function, a second message including a third parameter, which indicate no-redundancy to indicate that a second context is exclusively bound to a specific NF service instance within the second network function. In addition, the method may further comprise the step of deleting the second context if the second network function is not available.

In some embodiments, there proposes a method performed by a second network function. The method may comprise the step of receiving, from a first network function, a first message including a first parameter indicating no-redundancy to indicate that a first context is exclusively bound to a specific NF service instance within the first network function. The specific NF service instance may be identified in a binding indication included in the first message.

In an embodiment, the first message may further include a second parameter indicating a validation timer. The validation timer may indicate the validation period of no-redundancy.

In an embodiment, the method may further comprise the step of deleting the first context if the first network function is not available.

In an embodiment, the method may further comprise the step of deleting the first context if the first network function is not available when the validation timer indicates the redundancy level is within the validation period.

In an embodiment, the validation timer may be included in the binding indication or another HTTP header.

In an embodiment, the first network function may be a NF service producer, and the second network function may be a NF service consumer. In addition, the first context may be a resource context; and the first message may be a response message or a notification message.

In an embodiment, the first network function may be a NF service consumer, and the second network function may be a NF service producer. In addition, the first context may be a session context or a resource context; and the first message may be a request message or a subscription message.

In an embodiment, the first network function may act as home SMF for a Home-Routed PDU session, and the respective visit SMF for the Home-Routed PDU session does not support redundancy.

In an embodiment, the first network function may be taken out of a set of NFs, due to service software upgrade, downgrade, or maintenance.

In an embodiment, the first network function may temporarily lose a connection towards an UDSF, which is shared by a set of NFs.

In some embodiments, there proposes a network function. In an embodiment, the network function may comprise at least one processor; and a non-transitory computer readable medium coupled to the at least one processor. The non-transitory computer readable medium may store instructions executable by the at least one processor, whereby the at least one processor may be configured to perform any of the above methods. In an embodiment, the network function may be configured as the first network function or the second network function.

In some embodiments, there proposes a computer readable medium comprising computer readable code, which when run on an apparatus, may cause the apparatus to perform any of the above methods.

In some embodiments, there proposes a computer program product comprising computer readable code, which when run on an apparatus, may cause the apparatus to perform any of the above methods.

The embodiments allow the NF service instance to indicate the resource is exclusively bound to this NF service instance, there is no redundancy for the concerning resource using 3gpp-Sbi-Binding-Indication.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture for 5G network architecture at non-roaming scenario;

FIG. 2 is a schematic block diagram showing example architecture of a wireless communication system for indicating additional redundancy information;

FIG. 3 is a schematic signaling chart showing the messages in an example procedure for indicating additional redundancy information, according to the embodiments herein;

FIG. 4 is a schematic flow chart showing an example method in the first network function, according to the embodiments herein;

FIG. 5 is a schematic flow chart showing an example method in the second network function, according to the embodiments herein;

FIG. 6 is a schematic block diagram showing an example first network function, according to the embodiments herein;

FIG. 7 is a schematic block diagram showing an example second network function, according to the embodiments herein;

FIG. 8 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C” “B and C” or “A, B, and C”.

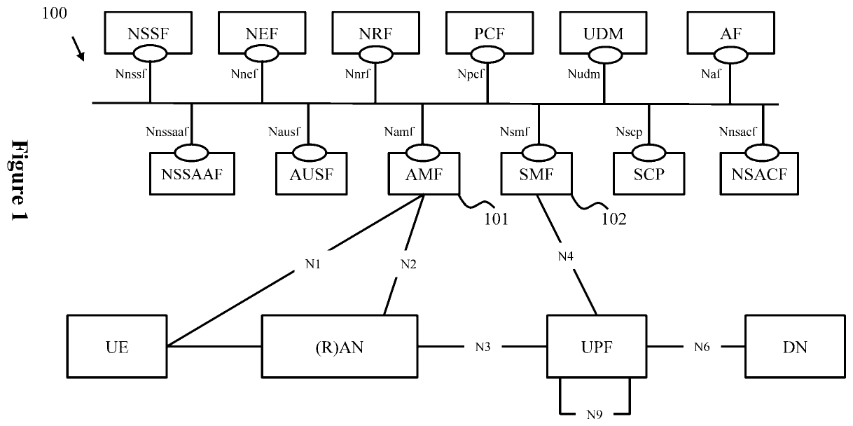

It should also be understood that, a network node (such as the AMF 101 or the SMF 102 in FIG. 1), which also may be referred as a network function, can be implemented either as a network element on a dedicated hardware, as a software instance running on a dedicated hardware, or as a virtualized function instantiated on an appropriate platform, e.g. on a cloud infrastructure.

In an embodiment, the communication system 100 may be configured in an Over The Top (OTT) scenario. The OTT connection may be transparent in the sense that the participating communication devices through which the OTT connection passes are unaware of routing of uplink and downlink communications. For example, a base station may not or need not be informed about the past routing of an incoming downlink communication with data originating from the network functions (such as the AMF 101 or the SMF 102) in the core network to be forwarded (e.g., handed over) to a connected User Equipment (UE). Similarly, the base station needs not be aware of the future routing of an outgoing uplink communication originating from the UE towards the network functions (such as the AMF 101 or the SMF 102) in the core network.

FIG. 1 is a schematic block diagram showing example architecture 100 for 5G network architecture at non-roaming scenario. In the 5G core network, the service-based architecture describes several interaction patterns, such as request/response pattern, or subscribe/notify pattern.

The subscribe/notify pattern assumes that a Network Function (NF) service consumer (such as the AMF 101) issues a request message (e.g., the “subscribe” operation) towards an NF service producer (such as the SMF 102). Then, when certain conditions occur at the NF service producer, it issues a subsequent request (i.e., the “notify” operation) towards the NF service consumer.

To ensure optimized data replication management, the NF producer or the NF consumer may indicate the preferred scope of data replication in the “subscribe”, “request”, “notify”, or “response” message, by using a binding indication.

The binding indication is information included by a NF service producer to a NF service consumer in responses or notifications to convey the scope within which selection/reselection of target NF/NF services may be performed, or information included by the NF service consumer in requests or subscriptions to convey the scope within which selection/reselection of notification targets or the selection of other service(s) that the NF consumer produces for the same data context may be performed.

Within the binding indication, the context owner (either the NF producer or the NF consumer) may define a binding level to define the preferred scope of NF reselection. An example binding level for binding, selection and reselection may be shown in the following table 1.

TABLE 1
binding, selection and reselection

| | | The NF Consumer/ | |
|---|---|---|---|
| | | Notification sender/SCP | |
| | The NF Consumer/ | can reselect e.g. when | Binding information for |
| Level of binding | Notification sender/SCP | selected producer is not | selection and |
| indication | selects | available | re-selection |
| NF Service Instance | The indicated NF Service | An equivalent NF Service | NF Service Instance ID, NF |
| | Instance | instance: | Service Set ID, NF |
| | | within the NF Service | Instance ID, NF Set ID, |
| | | Set (if applicable) | Service name (NOTE 2) |
| | | within the NF instance | |
| | | within the NF Set (if | |
| | | applicable) | |
| NF Service Set | Any NF Service instance | Any NF Service instance | NF Service Set ID, NF |
| | within the indicated NF | within an equivalent NF | Instance ID, NF Set ID, |
| | Service Set | Service Set within the NF | Service name (NOTE 2) |
| | | Set (if applicable) | |
| | | (Note 1) | |
| NF Instance | Any equivalent NF Service | Any equivalent NF Service | NF Instance ID, NF Set ID, |
| | instance within the NF | instance within a different | Service name (NOTE 2) |
| | instance. | NF instance within the NF | |
| | | Set (if applicable) | |
| NF Set | Any equivalent NF Service | Any equivalent NF Service | NF Set ID, Service name |
| | instance within the | instance within the NF Set | (NOTE 2) |
| | indicated NF Set | | |

Note 1:
NF Service Sets in different NFs are considered equivalent if they include same type and variant (e.g. identical NF Service Set ID) of NF Services.
NOTE 2:
The service name is only applicable if the Binding Indication relates to a notification target or If the NF as a NF consumer provides a Binding Indication for services that the NF produces.

When the peer NF received the binding indication, the peer NF, when detecting the original NF is not available, will first select candidates within the preferred scope (binding level). Only when all the candidates within the binding level are not available, the peer NF may reselect candidates outside of the binding level.

The reason for requirement of 3GPP TS29.500 may be due to a protocol limitation; the binding indication may include a preferred binding entity which is corresponding the binding level, and another binding entity for reselection. When binding level is NF service instance, the NF service instance ID (as preferred binding entity) must be included, however the NF service instance ID is not global unique, it has to be provisioned together with a NF instance ID or a NF service set ID, this leads ambiguity whether this NF instance ID/NF service set ID indicates it is for identifying the NF service instance, or it is to describe the binding entity for reselection.

However, there are several use cases that a NF may wish to indicate additional redundancy information for selecting/reselecting the NF service instance(s) or entity(s), in addition to the existing binding indication, for example the NF may wish to indicate that the resource is exclusively bound to a specific NF service instance.

Use case 1. Support of restoration procedures for a Home-Routed PDU Session or a PDU session with a I-SMF

When Visitor/Intermediate Session Management Function (V/I-SMF) doesn't support PSETR feature as specified by 3GPP TS29.502 (i.e., the V/I-SMF cannot reselect an alternative (Home) SMF (i.e., (H-)SMF) when it detects the (H-)SMF failure (not reachable) while the H-SMF support DLSET feature as specified by 3GPP TS29.502 (i.e. the (H-)SMF is deployed in a (H-)SMF SET), so when the (H-)SMF has a failure, the PDU session will be deleted by V/I-SMF while the PDU session resource is still kept in the shared memory, e.g. UDSF, the NFs behind the (H)-SMF, e.g. Policy Control Function/Unified Data Management (PCF/UDM) in the Home Public Land Mobile Network (PLMN) is unaware of the PDU session is not possible to be restored (since it is deleted in Visiting PLMN). So there needs means for enabling the hanging resource in PCF/UDM (e.g. in Home PLMN) to get deleted. One of solution could be that an alternative H-SMF in the same SMF set as the failed SMF pertain to somehow learns the failure of the (H-)SMF and knows the PDU session cannot be restored (due to V/I-SMF has deleted PDU session), and then trigger the deletion. This alternative requires complicated mechanism with a SMF set to enable the SMFs in the set can keep track of the status each SMF in the set.

Use case 2. A NF is taking out of a SMF set for the following scenarios:
In service software upgrade, i.e. being upgraded to a software version that makes new created resource be not possible to be shared by other NF service instances without being upgraded in the set;
Similar for downgrade;
Maintenance.

For example:

Assuming there are 5 NFs (1, 2, 3, 4 and 5) in the set, and the NF1 is being upgraded:
for any existing resource which were handled by the NF1:
   it would be better to let other NFs in the same NF set, this can be done via notification request(s) via changing the preferred binding entity in the binding indication, either per resource or per group of resource if supported; or
   at receiving a service request addressing to an existing resource created before it is moved out of the set, using 3xx to redirect.

While for any new request, especially for those requests require newly upgraded feature, the NF1 should accept the request, since the NF1 is the first NF in the set which has been upgraded, there is no redundancy. This has to indicate to the NF service consumer.

When later on the NF2 is also upgraded, the binding indication will be further updated since NF1 and NF2 can form a new set. At some points, the existing resources (created prior to NF1's upgrade) will be handled by the new set.

Use case 3. A NF (service) set is deployed using a UDSF as centralized database to store the resource information, so any NF in the same (service) set can retrieve the resource information, thus be able to handle the request related to the resource.

However, if the NF temporarily loses the connection towards the UDSF, in this case any resource created or updated by this NF cannot be synchronized and stored in the UDSF, i.e. those resources being newly created or updated cannot be served by other NF in the same set, i.e. they are exclusively bound to a specific NF service instance.

In view of the above deficiencies, the embodiments herein propose a mechanism to enable a NF service instance to indicate the resource is exclusively bound to this NF service instance, there is no redundancy for the concerning resource.

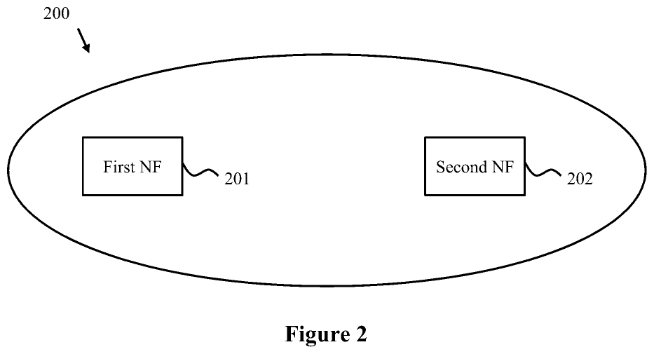

FIG. 2 is a schematic block diagram showing example architecture of a wireless communication system 200 for indicating additional redundancy information, for example indicating no redundancy.

In an embodiment, the wireless communication system 200 may include but not limited to a first NF 201 and a second NF 202. In an embodiment, the first NF 201 and the second NF 202 may be configured as any two of the NFs shown in FIG. 1.

In an embodiment, the first NF 201 may be a NF service consumer, the second NF 202 may be a NF service producer, and the message may be a request message or a subscription message. As an example, the first NF 201 may be the AMF 101 in FIG. 1, and the second NF 202 may be the SMF 102 in FIG. 1.

In another embodiment, the first NF 201 may be a NF service producer, the second NF 202 may be a NF service consumer, and the message may be a response message or a notification message.

In an embodiment, the first NF 201 may be configured to transmit a message to the second NF 202. In an embodiment, the first NF 201 may include a binding indication in the message.

In addition to the Binding Indication, the first NF 201 may further include additional redundancy information in the message. Such “additional redundancy information” may be included in the Binding Indication or in another HTTP header, or in a new HTTP customer header.

As an example, the additional redundancy information may include the following parameter in the following table 2.

TABLE 2
Definition of type AdditionalRedundancyInfo

| Attribute name | Data type | P | Cardinality | Description |
|---|---|---|---|---|
| redundancyLevel | RedundancyLevel | M | 1 | More information on the error shall be provided in |
| | | | | the “cause” attribute of the “ProblemDetails” |
| | | | | structure. |
| validityPeriod | DateTime | O | 0 . . . 1 | Timestamp until which the |
| | | | | AdditionalRedundancyInfo is valid. |

In an embodiment, a timer may indicate the validity period of the redundancy level, that is the additional redundancy information is valid until the timer is expired.

In an embodiment, the redundancy-level may be defined as Boolean value. When the redundancy-level is set as true, it may indicate that no redundancy is available. That is, the context may be exclusively bound to a specific NF service instance within the first network function.

In an embodiment, the redundancy-level may be defined as enumeration contains values, i.e., “no-redundancy” or “nfservinst”, “nfservset”, “nfinst”; this indicates to the receiver that the current redundancy level for the concerning resource or session context, despite the binding level in the binding indication. When the redundancy-level is set to “no-redundancy” or “nfservinst”, it indicates the resource is exclusively bound to this NF service instance.

As an example, the enumeration redundancy-level may include the following information in the following table 3. In the table 3, the enumeration RedundancyLevel indicates the current redundancy level.

TABLE 3
Enumeration RedundancyLevel

| Enumeration value | Description |
|---|---|
| “NO_REDUNDANCY” or | Indicates no redundancy, i.e. |
| “NF_SERVICE_INSTANCE” | bound to the specific NF |
| | service instance |
| “NF_SERVICE_SET” | bound to a NF service set |
| “NF_INSTANCE” | bound to a NF instance |

The redundancy level may have finer level than the binding entity indicated in the binding indication for re-selection. For example, if the binding indication indicates the binding level is an NF instance, the preferred binding entity is NF instance, the other binding entity (for reselection) is NF set. The redundancy level may be set to NF instance, so it instructs the receiver to respect the additional redundancy information, i.e. upon the failure, the receiver can only select an alternative NF service instance within the NF instance, not in the NF set until the validity period is expired. When the timer is expired, the receiver shall directly start to use the binding indication as the resilience information for the concerning resource or session context.

The binding indication may further include the binding entity corresponding to the redundancy level:
when redundancy level is “NO_REDUNDANCY” or “NF_SERVICE_INSTANCE”, the NF service instance ID may be present in the binding indication, e.g. nfservinst=xyz may be present.
when redundancy level is “NF_SERVICE_SET”, then NF service set ID (e.g. nfservset=setxyz.snnsmf-pdusession.nfi54804518-4191-46b3-955c-ac631f953 ed8.5gc.mnc012.mcc345) may be present in the binding indication.
when redundancy level is “NF_INSATNCE”, then NF Instance ID (e.g. nfinst=54804518-4191-46b3-955c-ac631f953ed8) may be present in the binding indication.

As seen above, there are some use cases where a NF wishes to indicate there is no redundancy for the resource, i.e., the resource is exclusively bound to a specific NF service instance even when the NF is or was part of a NF (service) set.

The embodiments aim to solve the problems/use cases when a NF wishes to indicate that the resource is exclusively bound to a specific NF service instance.

In the embodiments, there propose a new data type “redundancy-info” which includes “redundancy-level” as an enumeration contains “no-redundancy”. In particular, the embodiments allow the NF service instance to indicate the resource is exclusively bound to this NF service instance, there is no redundancy for the concerning resource using 3gpp-Sbi-Binding-Indication.

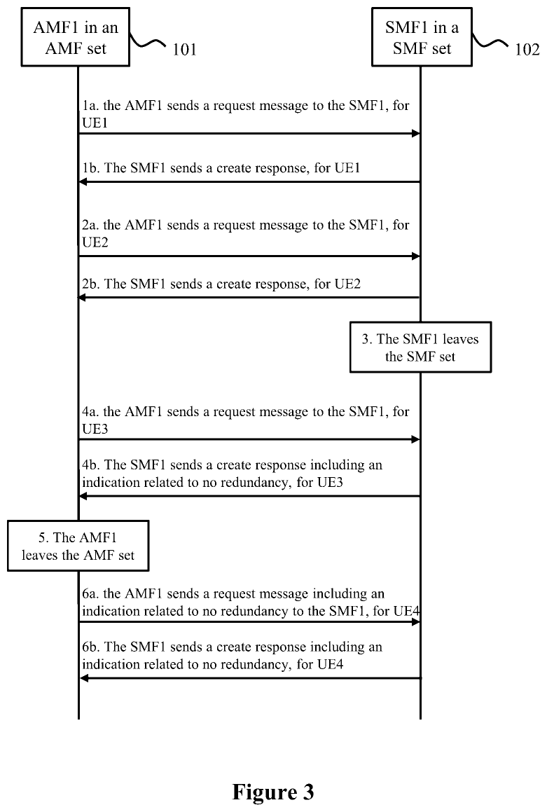

FIG. 3 is a schematic signaling chart showing the messages in an example procedure for indicating additional redundancy information (for example indicating no redundancy), according to the embodiments herein.

FIG. 3 shows how a NF, regardless of if it is a NF service consumer (such as the AMF 101) or NF service producer (such as the SMF 102), indicates to its peer NF that the resource or session context allocated in the NF producer or NF consumer, is exclusively bound to a specific NF service instance. In the example, the binding indication may be used to convey the additional redundancy information. To simplify, it is assumed that a NF instance (the AMF 101 or the SMF 102) contains only one NF service instance. For example, the AMF1 has a NF service instance abc; and the SMF1 has a NF instance xyz.

In an embodiment, the procedure for indicating additional redundancy information (for example indicating no redundancy) may include the following messages or steps:
Step 1a. To establish UE1's PDU session, the AMF1 sends a request message to the SMF1, to create a SmContext resource for the PDU session in the SMF1. In the request message, the AMF1 may include 3gpp-Sbi-Binding for callback (i.e., the session context for the PDU session corresponding to the SmContext resource in the SMF1).

For example, an example of 3gpp-Sbi-Binding may be 3gpp-Sbi-Binding: bl=nf-instance; nfinst=54804518-4191-46b3-955c-ac631f953ed7 (AMF1); nfset=set1.region48.amfset.5gc.mnc012.mcc345; scope=callback.

That is, the NF consumer's binding indication may include the binding level of NF instance and the identifier of the NF instance (AMF1).

Step 1b. The SMF1 may send the create response message which may include a location header containing the resource Uniform Resource Identifier (URI) which will be used by the AMF1 in the subsequent signaling related to this resource. The SMF1 may include 3gpp-Sbi-Binding: bl=nf-instance; nfinst=64804518-4191-46b3-955c-ac631f953ed8 (SMF1); nfset=set1. smfset.5gc.mnc012.mcc345.

That is, the NF producer's binding indication may indicate, for this resource, the binding level may be set to NF instance level. In addition, the identifier of the NF instance (SMF1) may be also included in the NF producer's binding indication.

Step 2a. To establish UE2's PDU session, the AMF1 may do the same and provide the same 3gpp-Sbi-Binding as in step 1a.

Step 2b. The SMF1 may do the same and provide the same 3gpp-Sbi-Binding as in step 1b.

Step 3. The SMF1 may leave the SMF set due to some reasons, e.g., upgrade, where the newly created resource contexts cannot be shared by other SMF(s) or other SMF service instance(s) in the SMF set.

Step 4a. To establish UE3's PDU session, the AMF1 may do the same and provide the same 3gpp-Sbi-Binding as in step 1a.

Step 4b. The SMF1 may send the create response message which may include a location header containing the resource URI which will be used by the AMF1 in the subsequent signaling related to this resource. The SMF1 may include 3gpp-Sbi-Binding: bl=nfserviceinstance; nfservinst=xyz; nfinst=64804518-4191-46b3-955c-ac631f953ed8; no-redundancy=true.

That is, the NF producer's binding indication may indicate, for this resource, the binding level may be set to NF service instance level. In addition, the identifier of the NF service instance (xyz) may be also included in the NF producer's binding indication.

In this example, the NF producer's binding indication may also include the additional redundancy information (for example, “no-redundancy=true”), to indicate, for this resource, there is no redundancy.

Here, in this example, the parameter “no-redundancy” is a Boolean value, which may be set as “true” or “false”. The parameter “no-redundancy” may be used to indicate if the resource is exclusively bound to the NF service instance as identified in the binding indication. The “nfservset” or “nfinst” included in the binding indication is only used to identify the NF service instance, but is not used as a binding entity for reselection.

Step 5. The AMF1 may leave the AMF set due to some reasons, e.g., upgrade, where for newly created resource context, the corresponding session context in consumer cannot be shared by other AMF(s) in the AMF set.

Step 6a. To establish UE4's PDU session, the AMF1 may provide a binding indication, e.g., 3gpp-Sbi-Binding: bl=nfserviceinstance; nfsercinst=abc; nfinst=54804518-4191-46b3-955c-ac631f953ed7; no-redundancy=true.

That is, the NF consumer's binding indication may indicate, for this resource, the binding level may be set to NF service instance level. In addition, the identifier of the NF service instance (abc) may be also included in the NF consumer's binding indication.

In this example, the NF consumer's binding indication may also include the additional redundancy information (for example, “no-redundancy=true”), to indicate, for this resource, there is no redundancy.

Step 6b. The SMF1 may send the create response message as it does in step 4b.

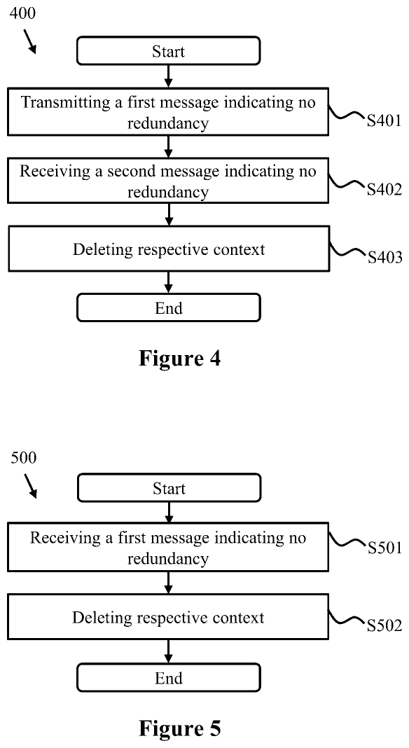

The embodiments of this disclosure will be further explained by referring to the flow charts of for example FIG. 4 and FIG. 5. FIG. 4 is a schematic flow chart showing an example method 400 in the first network function 201 (either NF consumer or NF producer), according to the embodiments herein.

The method 400 may begin with step S401, in which the first network function 201 may transmit, to a second network function 202, a first message including a first parameter indicating no-redundancy to indicate that a first context is exclusively bound to a specific NF service instance within the first network function 201. The specific NF service instance may be identified in a binding indication included in the first message.

In an embodiment, the message may further include a second parameter indicating a validation timer. The validation timer may indicate the validation period of no-redundancy.

In an embodiment, the validation timer may be included in the binding indication or another HTTP header.

In an embodiment, the first network function 201 may be a NF service producer (such as the SMF 102), and the second network function 202 may be a NF service consumer (such as the AMF 101). In addition, the first context may be a resource context; and the first message may be a response message or a notification message.

In an embodiment, the first network function 201 may be a NF service consumer (such as the AMF 101), and the second network function 202 may be a NF service producer (such as the SMF 102). In addition, the first context may be a session context or a resource context; and the first message may be a request message or a subscription message.

In an embodiment, the first network function 201 may act as home SMF for a Home-Routed PDU session, and the respective visit SMF for the Home-Routed PDU session does not support redundancy.

In an embodiment, the first network function 201 may be taken out of a set of NFs, due to service software upgrade, downgrade, or maintenance.

In an embodiment, the first network function 201 may temporarily lose a connection towards an UDSF, which is shared by a set of NFs.

Then, the method 400 may proceed to step S402, in which the first network function 201 may receive, from the second network function 202, a second message including a third parameter, which indicate no-redundancy to indicate that a second context is exclusively bound to a specific NF service instance within the second network function 202.

Then, the method 400 may proceed to step S403, in which the first network function 201 may delete the second context if the second network function 202 is not available.

The above steps are only examples, and the first network function 201 may perform any actions described with respect to FIGS. 2-3, to allow the NF to populate the information related to redundancy (for example indicating no-redundancy) and handling accordingly.

FIG. 5 is a schematic flow chart showing an example method 500 in the second network function 202 (either NF producer or NF consumer), according to the embodiments herein.

The method 500 may begin with step S501, in which the second network function 202 may receive, from a first network function 201, a first message including a first parameter indicating no-redundancy to indicate that a first context is exclusively bound to a specific NF service instance within the first network function 201. The specific NF service instance may be identified in a binding indication included in the first message.

In an embodiment, the message may further include a second parameter indicating a validation timer. The validation timer may indicate the validation period of no-redundancy.

In an embodiment, the validation timer may be included in the binding indication or another HTTP header.

In an embodiment, the first network function 201 may be a NF service producer (such as the SMF 102), and the second network function 202 may be a NF service consumer (such as the AMF 101). In addition, the first context may be a resource context; and the first message may be a response message or a notification message.

In an embodiment, the first network function 201 may be a NF service consumer (such as the AMF 101), and the second network function 202 may be a NF service producer (such as the SMF 102). In addition, the first context may be a session context or a resource context; and the first message may be a request message or a subscription message.

In an embodiment, the first network function 201 may act as home SMF for a Home-Routed PDU session, and the respective visit SMF for the Home-Routed PDU session does not support redundancy.

In an embodiment, the first network function 201 may be taken out of a set of NFs, due to service software upgrade, downgrade, or maintenance.

In an embodiment, the first network function 201 may temporarily lose a connection towards an UDSF, which is shared by a set of NFs.

Then, the method 500 may proceed to step S502, in which the second network function 202 may delete the first context if the first network function 201 is not available. Alternatively, the second network function 202 may delete the first context if the first network function 201 is not available when the validation timer indicates no redundancy is within the validation period.

The above steps are only examples, and the second network function 202 may perform any actions described with respect to FIGS. 2-3, to allow the NF to populate the information related to redundancy (for example indicating no-redundancy) and handling accordingly.

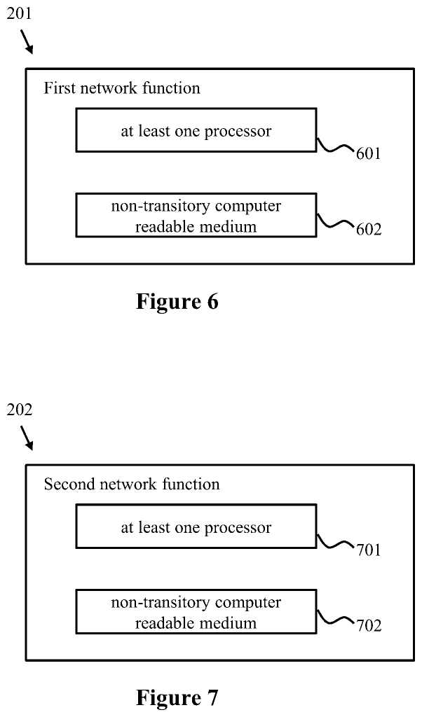

FIG. 6 is a schematic block diagram showing an example first network function 201, according to the embodiments herein.

In an embodiment, the first network function 201 may include at least one processor 601; and a non-transitory computer readable medium 602 coupled to the at least one processor 601. The non-transitory computer readable medium 602 may store instructions executable by the at least one processor 601, whereby the at least one processor 601 may be configured to perform the steps in the example method 400 as shown in the schematic flow chart of FIG. 4; the details thereof are omitted here.

Note that, the first network function 201 may be implemented as hardware, software, firmware and any combination thereof. For example, the first network function 201 may include a plurality of units, circuities, modules or the like, each of which may be used to perform one or more steps of the example method 400 or one or more steps related to the first NF 201 (either the AMF 101 or the SMF 102).

It should be understood that, the first network function 201 may be implemented either as a network element on a dedicated hardware, as a software instance running on a dedicated hardware, or as a virtualized function instantiated on an appropriate platform, e.g. on a cloud infrastructure.

FIG. 7 is a schematic block diagram showing an example second network function 202, according to the embodiments herein.

In an embodiment, the second network function 202 may include at least one processor 701; and a non-transitory computer readable medium 702 coupled to the at least one processor 701. The non-transitory computer readable medium 702 may store instructions executable by the at least one processor 701, whereby the at least one processor 701 may be configured to perform the steps in the example method 500 as shown in the schematic flow chart of FIG. 5; the details thereof are omitted here.

Note that, the second network function 202 may be implemented as hardware, software, firmware and any combination thereof. For example, the second network function 202 may include a plurality of units, circuities, modules or the like, each of which may be used to perform one or more steps of the example method 500 or one or more steps related to the second NF 202 (either the SMF 102 or the AMF 101).

It should be understood that, the second network function 202 may be implemented either as a network element on a dedicated hardware, as a software instance running on a dedicated hardware, or as a virtualized function instantiated on an appropriate platform, e.g. on a cloud infrastructure.

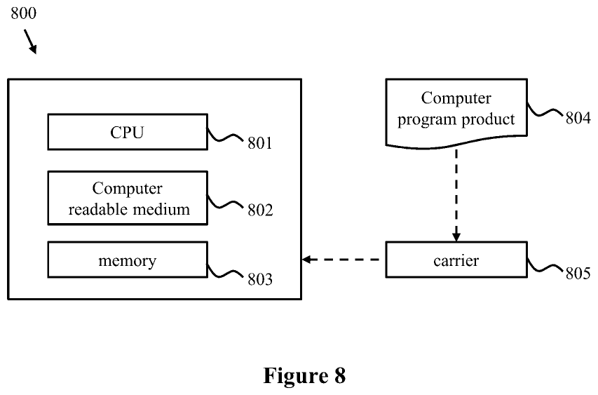

FIG. 8 is a schematic block diagram showing an example computer-implemented apparatus 800, according to the embodiments herein. In an embodiment, the apparatus 800 may be configured as the above mentioned apparatus, such as the AMF 101, the SMF 102, the first NF 201, or the second NF 202.

In an embodiment, the apparatus 800 may include but not limited to at least one processor such as Central Processing Unit (CPU) 801, a computer-readable medium 802, and a memory 803. The memory 803 may comprise a volatile (e.g., Random Access Memory, RAM) and/or non-volatile memory (e.g., a hard disk or flash memory). In an embodiment, the computer-readable medium 802 may be configured to store a computer program and/or instructions, which, when executed by the processor 801, causes the processor 801 to carry out any of the above mentioned methods.

In an embodiment, the computer-readable medium 802 (such as non-transitory computer readable medium) may be stored in the memory 803. In another embodiment, the computer program may be stored in a remote location for example computer program product 804 (also may be embodied as computer-readable medium), and accessible by the processor 801 via for example carrier 805.

The computer-readable medium 802 and/or the computer program product 804 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Specification 3GPP TS 29.500 V17.7.0.

Title: Binding Indication for the resource bound to a specific NF service instance

### Reason for Change:

As specified in TS29.500, it is not possible to use Binding Indication to indicate that the resource is exclusively bound to a specific NF service instance:

Binding Indications shall not be used if a particular resource can only be served by a specific NF service instance of an NF instance, i.e. if NF service instances of a same NF service are not capable to share resource inside the NF Instance. A resource for which no Binding Indication or Routing Binding Indication is signaled shall be considered to be bound exclusively to one NF service instance, unless the NF Service resource owner instance is part of an NF set (or AMF set) or an NF service set, or unless its NF profile in the NRF indicates that its supports NF service persistence within the NF instance (see clause 6.5 of 3GPP TS 23.527 [38]).

The italic highlighted requirements force the receiving NF (consumer or producer) to perform service discovery procedure towards NRF to determine if the resource is really bound to a specific NF service instance, since the producer may not support binding indication.

In addition, there are several use cases where a NF may wish to indicate the resource is exclusively bound to a specific NF service instance:
1. Support of restoration procedures for a Home-Routed PDU Session or a PDU session with a I-SMF

When V/I-SMF doesn't support PSETR feature (i.e. the V/I-SMF can NOT reselect an alternative (H-)SMF when it detects the (H-)SMF failure(not reachable) while the H-SMF support DLSET feature (i.e. the (H-)SMF is deployed in a (H-)SMF SET), so when the (H-)SMF has a failure, the PDU session will be deleted by V/I-SMF while the PDU session resource in HPLMN is still kept in the shared memory, e.g. UDSF, the NFs behind the (H)-SMF, e.g. PCF/UDM in the Home PLMN is unaware of the PDU session is NOT possible to be restored since it is deleted in Visiting PLMN. So, we need a mean to enable the hanging resource in PCF/UDM (e.g. in HPLMN) to get deleted. One of solution could be that an alternative H-SMF in the same SMF set as the failed SMF pertain to somehow learns the failure of the (H-)SMF and knows the PDU session cannot be restored (due to V/I-SMF has deleted PDU session), and then trigger the deletion. This alternative requires complicated mechanism with a SMF set to enable the SMFs in the SET can keep track of the status each SMF in the set.
2. When a NF service instance is taking out of a set for the following scenarios:
   In Service Software Upgrade, i.e. being upgraded to a software version that makes new created resource be not possible to be shared by other NF service instances without being upgraded in the set;
   Similar for downgrade.
   Maintenance.

For example:

Assuming there are 5 NFs (1, 2, 3, 4 and 5) in the SET, NF1 is being upgraded:

For any existing resource which were handled by the NF1:
it would be better to let other NFs in the same NF set, this can be done via Notification request(s) via changing the Preferred binding entity in the binding indication, either per resource or per group of resource if supported; or
at receiving a service request addressing an existing resource created before it is moved out of the SET, using 3xx to redirect.

While for any new request, especially for those requests requires newly upgraded feature, the NF1 should accept the request, since the NF1 is the first NF in the set which has been upgraded, there is no redundancy. This must indicate to the NF service consumer.
3. A NF (service) Set is deployed using a UDSF as centralized database to store the resource information, so any NF in the same (service) set can retrieve the resource information, thus be able to handle the request related to the resource.

However, when the NF temporarily loses the connection towards the UDSF, in this situation any resource created or updated by this NF can not be synchronized and stored in the UDSF, i.e. those resources being newly created or updated can not be served by other NF in the same Set, i.e. they are exclusively bound to a specific NF service instance.

So, it is proposed to introduce a new parameter “no-redundancy” as a boolean to indicate if the resource/session context is exclusively bound to a specific NF service instance in the 3gpp-Sbi-Binding.

### Summary of Change:

Introduce a new parameter “no-redundancy” as a boolean to indicate if the resource/session context is exclusively bound to a specific NF service instance in the 3gpp-Sbi-Binding and relevant description for the parameter.

### Consequences if not Approved:

Some use cases where a NF wants to indicate the resource is exclusively bound to a specific resource are not supported.

```
  Proposed changes:
  *** 1st Change *** (the underline indicates the content to be added
to the 3GPP Technical Specification)
  6.1.6.1 General
  This clause specifies the application data model supported by the API.
  5.2.3.2.63gpp-Sbi-Binding
  This header contains a comma-delimited list of Binding Indications
from an HTTP server for storage and subsequent use by an HTTP client
(see clause 6.12).
  The encoding of the header follows the ABNF as defined in IETF
RFC 7230 [12].
  3gpp-Sbi-Binding = “3gpp-Sbi-Binding” “:” 1#(OWS “bl=” blvalue
1*(“;” OWS parameter) [“;” OWS recoverytime] [“;” OWS notif-receiver]
[“;” OWS “group=” groupvalue] [1*(“;” OWS groupparameter)])
  blvalue = “nf-instance” / “nf-set” / “nfservice-instance” /
“nfservice-set”
  parameter = parametername “=” token
  parametername = “nfinst” / “nfset” / “nfservinst” / “nfserviceset” /
“servname” / “scope” / “backupamfinst” / “backupnf”
  recoverytime = “recoverytime=” OWS DQUOTE date-time DQUOTE
  notif-receiver = “nr=” URI ; URI production rule from IETF RFC
3986 [14], Appendix A
  groupvalue = “true” / “false”
  groupparameter = groupparametername “=” token
  groupparametername = “oldgroupid” / “groupid” / “uribase” /
“oldnfinst / “oldservset” / “oldservinst” / “guami”
  no-redundancy= “true” / “false”
```

The following parameters are defined:
scope: indicates the applicability of a Binding Indication in a service request other than a notification request, or in a notification or callback response. This may take one of the following values:
“other-service”: the binding information applies to other service(s) that the NF Service Consumer may later on provide as an NF Service Producer (see clause 6.12.3);
“subscription-events”: the binding information applies to subscription change event notifications (see clause 6.12.4);
“callback”: the binding information applies to notification or callback requests (see clauses 6.12.4 and 6.12.5).

The absence of this parameter in a Binding Indication in a service request other than a notification request, or in a notification or callback response, shall be interpreted as “callback”.

Two scope parameters may be present in a Binding Indication if the binding information applies to notification/callback requests and to other services.
servname (service name): indicates the name of a service, as defined in 3GPP TS 29.510 [8], or a custom service, i.e.:
the name of the service that handles a notification or a callback request, when present in a Binding Indication for a subscription or a callback, i.e. with a scope parameter absent or set to “callback”; or
the name of the other service(s) for which the binding applies, when present in a Binding Indication in a service request for the other services the NF Service Consumer can provide later on as an NF Service Producer, i.e. with the scope parameter set to “other-service”. More than one servname parameter may be present to represent multiple such services. The absence of this parameter in a Binding Indication with the scope parameter set to “other-service” shall be interpreted as binding information that applies to all the services that the NF Service Consumer may provide later as an NF Service Producer.
recoverytime: indicates the recovery timestamp of the entity corresponding to the highest resiliency level supported for the resource, that is, the higher level binding entity indicated in the Binding Indication. See Table 6.3.1.0-1 of 3GPP TS 23.501 [3] and clause 6.1 of 3GPP TS 23.527 [38]. The date-time type is specified in IETF RFC 5322 [37] and clause 7.1.1.1 of IETF RFC 7231 [11].
nr: indicates the URI of the notification endpoint when this binding information is applicable; it applies to callback requests (see clause 6.12.4); if the notification URI does not contain a correlationID in the path (i.e. it is a common notification URI for multiple subscriptions), the correlationID shall be added as a fragment component of the URI (i.e. following the “#” character) at the end of the URI.
for the definition and encoding of the blvalue, nfinst, backupamfinst, nfset, nfservinst and nfserviceset see clause 5.2.3.2.5.
backupnf: indicates the backup NF service instance identifier and/or the backup NF identifier as defined in clause 5.2.2.2.2 or in 3GPP TS 29.510 [8], which shall be used when preferred binding entity is not reachable if supported.
group: it is a boolean indicating if the binding indication is for a group of resource/session contexts.
groupid (group id): indicates the group identifier allocated by the NF (service) instance, one ore more resource/session contexts are sharing the same groupid. The groupid is optional and it may be allocated when the resource/session context is created and then be updated afterwards. The groupid is global unique and it may be encoded using the same mechanism for the NfInstanceId as specified in 3GPP TS 29.571 [13].
oldgroupid (old group id): indicates the group identifier allocated by the NF (service) instance previously and to be replaced by the groupid, hence it shall only be present when to update a Binding Indication for multiple contexts. When the if the oldgroupid is present, the groupid shall also be present to indicate the new groupid allocated.
uribase: identify the apiroot and path segments part in the resource URI or notification/callback URI which is common to multiple contexts. This parameter may only be present when to update a Binding Indication for multiple contexts and when the “group” is set to “true”. When included, it indicates that all resources or notification contexts with this uribase will use the updated Binding Indication subsequently. More than one uribase may be present.
oldnfinst: indicates the NF Instance ID of the NF instance where the group of resource/session contexts are currently served (i.e. the Binding Indication allocated previously for the group of resource/session contexts includes the information of the NF instance), as defined in clause 5.2.2.2.2 in 3GPP TS 29.510 [8]. When included, it indicates that all the resource/session contexts served by this NF instance will use the updated Binding Indication subsequently.
oldservset: indicates the NF Service Set ID of the NF Service Set where the group of resource/session contexts are currently served (i.e. the Binding Indication allocated previously for the group of resource/session contexts includes the information of the NF Service Set), as defined in clause 5.2.2.2.2 in 3GPP TS 29.510 [8]. When included, it indicates that all the resource/session contexts served by this NF Service Set will use the updated Binding Indication subsequently.
oldservinst: indicates the NF Service Instance ID of the NF service instance where the group of resource/session contexts are currently served (i.e. the Binding Indication allocated previously for the group of resource/session contexts includes the information of the NF service instance), as defined in clause 5.2.2.2.2 in 3GPP TS 29.510 [8]. When included, it indicates that all the resource/session contexts served by this NF service instance will use the updated Binding Indication subsequently.
guami (GUAMI): indicates the GUAMI of the AMF currently serving UE contexts, as defined in clause 5.3.4.1 of 3GPP TS 29.571 [13]. When included, it indicates that all the UE contexts associated with the GUMAI will use the updated Binding Indication subsequently.
no-redundancy: it is a boolean indicating if the resource is exclusively bound to the NF service instance as identified in the binding indication. When it is set to true, the nfservset or nfinst included in the binding indication shall only be used to identify the NF service instance, and should not be considered as a binding entity for reselection.

EXAMPLES 1 to 5: Same as EXAMPLES 1 to 5 defined in clause 5.2.3.2.5, with the header name “3gpp-Sbi-Binding” instead of “3gpp-Sbi-Routing-Binding”.

EXAMPLE 6: Subscription request from one NF on behalf of another NF, with 2 binding indications:
3gpp-Sbi-Binding: bl=nf-set; nfset=set1.udmset.5gc.mnc012.mcc345; servname=nudm-ee; scope=subscription-events
3gpp-Sbi-Binding: bl=nf-set; nfset=set1.nefset.5gc.mnc012.mcc345; servname=nnef-event-exposure

EXAMPLE 7: Service request with 2 binding indications, for callback requests and for other services the NF Service Consumer may provide later as an NF Service Producer:
3gpp-Sbi-Binding: bl=nf-instance; nfinst=54804518-4191-46b3-955c-ac631f953ed8; nfset=set1.smfset.5gc.mnc012.mcc345; servname=nsmf-pdusession
3gpp-Sbi-Binding: bl=nf-instance; nfinst=54804518-4191-46b3-955c-ac631f953ed8; nfset=set1.smfset.5gc.mnc012.mcc345; scope=other-service; servname=nsmf-event-exposure

EXAMPLE 8: Service request with one binding indication applying to notification/callback requests and to any other services the NF Service Consumer may provide later as an NF Service Producer:
3gpp-Sbi-Binding: bl=nf-set; nfset=set1.region48.amfset.5gc.mnc012.mcc345; scope=callback; scope=other-service

EXAMPLE 9: Service request with one binding indication applying to notification/callback requests together with a recovery time stamp associated with the NF Set indicated in the binding indication and with the binding level set to “nfset”:
3gpp-Sbi-Binding: bl=nfset; nfset=set1.region48.amfset.5gc.mnc012.mcc345; scope=callback; recoverytime=“Tue, 4 Feb. 2020 08:49:37 GMT”

EXAMPLE 10: Service response with one binding indication applying to the session context with a recovery time stamp associated with the NF Set indicated in “nfset” in the binding indication and with the binding level set to “nfinstance”:
3gpp-Sbi-Binding: bl=nfinstance; nfinst=54804518-4191-46b3-955c-ac631f953ed8; nfset=set1.smfset.5gc.mnc012.mcc345; recoverytime=“Tue, 4 Feb. 2020 08:49:37 GMT”

EXAMPLE 11: Service response with one binding indication applying to the session context with a recovery time stamp associated with the NF Instance included the binding indication and with the binding level set to nfserviceinstance:
3gpp-Sbi-Binding: bl=nfserviceinstance; nfservinst=xyz; nfinst=54804518-4191-46b3-955c-ac631f953ed8; recoverytime=“Tue, 4 Feb. 2020 08:49:37 GMT”

EXAMPLE 12: Service response with one binding indication applying to the resource context pertaining to a group identified by “54804518-4191-46b3-955c-ac631f953ed1” together with a backup nf:
3gpp-Sbi-Binding: bl=nfinstance; nfinst=54804518-4191-46b3-955c-ac631f953ed0; nfset=set1.smfset.5gc.mnc012.mcc345; groupid=54804518-4191-46b3-955c-ac631f953ed1; backupnf=54804519-4191-46b3-955c-ac631f953ed2

EXAMPLE 13: A notification request message with one binding indication applying to the resource contexts with the oldgroup identifier “54804518-4191-46b3-955c-ac631f953ed1”, where the preferred binding entity is changed to “nfinst=54804519-4191-46b3-955c-ac631f953ed0” together with a new group identifier “54804519-4191-46b3-955c-ac631f953ed3” allocated.
3gpp-Sbi-Binding: bl=nfinstance; nfinst=54804519-4191-46b3-955c-ac631f953ed0; nfset=set1.smfset.5gc.mnc012.mcc345; group=true; oldgroupid=54804518-4191-46b3-955c-ac631f953ed1; groupid=54804519-4191-46b3-955c-ac631f953ed3

EXAMPLE 14: A notification request message with one binding indication applying to the resource contexts identified by an uribase, where the preferred binding entity is changed to “nfinst=54804519-4191-46b3-955c-ac631f953ed0”:
3gpp-Sbi-Binding: bl=nfinstance; nfinst=54804519-4191-46b3-955c-ac631f953ed0; nfset=set1.smfset.5gc.mnc012.mcc345; group=true; uribase=http %3A %2F %2F10.10.10.10%2Fstringxyz

EXAMPLE 15: A notification request message with one binding indication applying to the resource contexts served by the NF instance identified by “64804518-4191-46b3-955c-ac631f953ed8” where the preferred binding entity is changed to “nfinst=74804519-4191-46b3-955c-ac631f953ed0”.
3gpp-Sbi-Binding: bl=nfinstance; nfinst=74804519-4191-46b3-955c-ac631f953ed0; nfset=set1.smfset.5gc.mnc012.mcc345; group=true; oldnfinst=64804518-4191-46b3-955c-ac631f953ed8

EXAMPLE 16: Service request message with an updated binding indication applying to the UE contexts for GUAMI” <mnc(012)><mcc(345)><AmfId(“abcd12”)> where the backupamfinst is changed.
3gpp-Sbi-Binding: bl=nf-instance; nfinst=54804518-4191-46b3-955c-ac631f953ed7; backupamfinst=54804520-4191-46b3-955c-ac631f953ed8; scope=other-service; group=true; guami={“plmnId”:{“mnc”:“012”,“mcc”:“345” },“amfld”:“abcd12” }

EXAMPLE X: Service response with a binding indication applying to the resource context which is exclusively bound to a specific NF service instance.
3gpp-Sbi-Binding: bl=nfserviceinstance; nfservinst=xyz; nfinst=54804518-4191-46b3-955c-ac631f953ed8; no-redundancy=true

NOTE: Examples 6 and 7 are formatted as two distinct headers (which improves the readability), but they can also be formatted as a single header with two Binding Indication values separated by a comma.

### *** 2nd Change *** (the Underline Indicates the Content to be Added to the 3GPP Technical Specification)

### 6.12.1 General

A Binding Indication for an NF Service Resource may be provided to an NF Service Consumer of the resource as part of the Direct or Indirect Communication procedures, to be used in subsequent related service requests. This allows the NF Service Resource owner to indicate that the NF Service Consumer, for a particular resource, should be bound to an NF service instance, NF instance, NF service set or NF set. See clause 6.3.1.0 of 3GPP TS 23.501 [3] and clause 4.17.12 of 3GPP TS 23.502 [4].

A binding may be established or updated as part of a:
1) service response creating or modifying a resource, to be used for subsequent requests targeting this resource (see clause 4.17.12.2 of 3GPP TS 23.502 [4]), for any API that defines resources;
2) service request, if the NF Service Consumer can also act as an NF Service Producer for later communication from the contacted NF Service Producer, to be used for subsequent service requests initiated by the contacted NF Service Producer (see clause 4.17.12.3 of 3GPP TS 23.502 [4]);
3) service request creating or modifying an explicit or an implicit subscription, or as part of a notification response, to be used for subsequent notification requests initiated by the NF Service Producer (see clause 4.17.12.3 of 3GPP TS 23.502 [4]);
4) service response creating an implicit or explicit subscription or updating a subscription, or as part of a notification request, to be used for subsequent operations on the subscription (see clause 4.17.12.4 of 3GPP TS 23.502 [4]);
5) service request creating a callback (other than notification) resource (e.g. V-SMF or I-SMF callback URI sent to the H-SMF or SMF), or as part of a callback response, to be used for subsequent callback requests initiated by the NF Service Producer (e.g. H-SMF or SMF initiated PDU session modification);
6) callback request sent from a NF Service Producer to update the binding for the resource context, to be used by the NF Service Consumer for subsequent service requests addressing the resource context.

Two types of binding information are defined to manage the binding between an NF Service Consumer and an NF Service Resource:
1) A Binding Indication conveys binding information for a resource which must be stored by the consumer (client) of that resource and used by the client to direct future requests to the resource. When contained in a service request, the binding information is associated with a resource owned by the NF Service Consumer for the current transaction. When contained in a service response, the binding information is associated with a resource owned by the NF Service Producer for the current transaction.
2) A Routing Binding Indication conveys binding information to direct a request from a client to a server which has the context. A Routing Binding Indication shall only be contained in an HTTP request.

A same service request may convey more than one Binding Indication, e.g.:
to provide bindings for notification or callback (i.e. bullets 3 or 5) and for other services that the NF service consumer can provide later as a NF Service Producer (i.e. bullet 2); or
to provide binding information for different event notifications, when creating a subscription on behalf of another NF (see clause 6.12.4).

The scope parameter in a Binding Indication in a service request (or notification or callback response) identifies the applicability of (i.e. scenario associated with) the binding information.

A service request may convey one or more Binding Indications as described above using a 3gpp-Sbi-Binding header and/or include a Binding Routing Indication to influence routing of the request e.g. to an appropriate set of NF Service Producers or to an appropriate service set of the NF Service Producer using a 3gpp-Sbi-Routing-Binding header. A service response may convey a Binding Indication for a resource using a 3gpp-Sbi-Binding header.

NOTE 1: An HTTP request can contain for instance one 3gpp-Sbi-Binding header containing two Binding Indications for other services and for callbacks, and one 3gpp-Sbi-Routing-Binding header conveying a Routing Binding Indication.

Once a binding indication has been received for a particular resource or scope, the absence of a binding indication for the same resource or scope in a subsequent request/response message shall be interpreted as meaning that the earlier received binding indication for that resource or scope has not changed, unless specified otherwise in the rest of the specification (see scenarios with NF service producer or consumer change further down, and clause 6.12.4 for inter-AMF mobility scenarios).

In scenarios with NF service producer change (e.g. V-SMF or I-SMF change), the NF service consumer (e.g. AMF) shall delete any earlier binding indication received from the old NF service producer (e.g. old V-SMF/I-SMF) for the producer's resource (e.g. SM context resource) and replace it by any new binding indication possibly received from the new NF service producer (e.g. new V-SMF/I-SMF).

In scenarios with NF service consumer change (e.g. inter-AMF mobility), the NF service producer (e.g. SMF) shall delete any earlier binding indication received from the old NF service consumer (e.g. binding indication for callback request received from the old AMF) and replace it by any new binding indication possibly received from the new NF service consumer (e.g. new AMF).

If an SCP receives a Routing Binding Indication within a service or notification request and decides to forward that request to a next-hop SCP, it shall include the Routing Binding Indication in the forwarded request. The SCP shall remove the Routing Binding Indication if it forwards the request to the target NF.

Binding Indications and Routing Binding Indications shall include the Binding level and one or more Binding entity IDs representing all NF service instances that are capable to serve service requests targeting the resource, i.e. that share the same resource contexts.

The Binding Level indicates a preferred binding to either a NF Instance, a NF set, a NF Service Instance or a NF Service Set.

When sending a request targeting the resource context in a NF Service Producer or the session context in a NF Service Consumer, the resource URI received in the Location header or the Notification/Callback URI shall be used first if available to set the “3gpp-Sbi-Target-apiRoot” header or target URI; as an exception, if the binding indication earlier received for the target resource context or session context indicates a binding level of “NF service set”, “NF Instance” or “NF Set” and alternative NF service instances within the preferred binding entity corresponding to the binding level are available, the request may alternatively be sent to one of these alternative NF service instances. When the URI received in the Location header or the Notification/Callback URI is not reachable or when becoming aware of a NF Service Producer or Consumer change as specified in bullet 3 of clauses 6.5.3.2 and 6.5.3.3, the binding entity corresponding to the binding level shall be selected whenever possible. If this is not possible, e.g. because the preferred binding entity is not reachable, the request should be sent to any other Binding entity signalled in the Binding Indication or Routing Binding Indication, in the following decreasing order of priority:
select an NF service instance if available in the backup NF instance, if a backup NF service instance and/or backup NF instance was signalled in the Binding Indication or Routing Binding Indication;
select an NF service instance in the same NF service set, if a NF service Set ID was signalled in the Binding Indication or Routing Binding Indication;
select an equivalent NF service instance in the same NF instance, if an NF instance ID was signalled in the Binding Indication or Routing Binding Indication;
select an NF service instance in an equivalent NF service set of the backup AMF instance, if a NF service Set ID and backup AMF Instance ID was signalled in the Binding Indication or Routing Binding Indication;
select an equivalent NF service instance in the backup AMF instance, if backup AMF Instance ID was signalled in the Binding Indication or Routing Binding Indication;
select an NF service instance in an equivalent NF service set of another NF instance of the NF set, if an NF Service Set ID and an NF Set ID were signalled in the Binding Indication or Routing Binding Indication;
select an equivalent NF service instance in another NF instance of the NF Set, if an NF Set ID was signalled in the Binding Indication or Routing Binding Indication.

NOTE 2: NF service instances from different NF instances are equivalent NF service instances if they share the same MCC, MNC, NID (for SNPN), ServiceName, API version, and, if applicable, NF Service Set ID (see clause 28.13 of 3GPP TS 23.003 [15]).

Binding Indications shall not be used if a particular resource can only be served by a specific NF service instance of an NF instance, i.e. if NF service instances of a same NF service are not capable to share resource inside the NF Instance unless the receiver of the Binding Indication has indicated its support of the no-redundancy indication in the Binding Indication in the SupportFeatures attribute for a specific API. A resource for which no Binding Indication or Routing Binding Indication is signalled shall be considered to be bound exclusively to one NF service instance, unless the NF Service resource owner instance is part of an NF set (or AMF set) or an NF service set, or unless its NF profile in the NRF indicates that its supports NF service persistence within the NF instance (see clause 6.5 of 3GPP TS 23.527 [38]).

An NF service producer supporting different sets of NF service instances, e.g. serving different network slices, shall include the NF Service Set ID in the Binding Indication to enable the reselection (when required) of an alternative NF service instance from the same or an equivalent NF service set. See also clause 6.10.3.2 for requirements on the inclusion of “3gpp-Sbi-Discovery-*” headers in service requests targeting an existing resource context in the NF service producer.

A Binding Indication may be shared by multiple resource/session contexts, i.e. these resource contexts (in the NF Service Producer) or session contexts (in the NF Service Consumer) are sharing the same resilience information. The Binding Indication for multiple contexts has the same semantics as the one for a single resource/session context but with the following additions. When it is supported as indicated in the Supported Features for a specific service API:
both NF Service Consumer and NF Service Producer can indicate if the Binding Indication for multiple contexts; and if the Binding Indication is for multiple contexts, the “group” parameter in the Binding Indication shall be set to “true”;
a group id may be included in the Binding Indication to indicate the group to which resource/session contexts pertain are sharing the same Binding Indication, when the resource/session context is created;
the Binding Indication for a group of contexts may be updated towards each Resource URI with different apiRoot part (representing different peer NF (service) instances) or towards each Notification URI with different authority part, or with the same authority part but different callback-uri-prefix (see clause 5.2.3.3.7) if it is provided in 3gpp-Sbi-Consumer-Info header when the NF service consumer provides the Callback URI, e.g. when the NF is changed, by including an oldgroupid, oldnfinst, oldservset, oldservinst or uribase to address applicable contexts for the update of the Binding Indication. When the oldgroupid is present, the groupid shall also be present to indicate the new group id which is newly allocated. Additionally, the Binding Indication may be updated for a group of UE contexts by including the gumai to address applicable UE contexts for the update of the Binding Indication.

### *** End of Changes ***

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### Abbreviations

3GPP 3rd Generation Partnership Project
5G fifth generation of mobile communication technology
AMF Access and Mobility Management Function
HTTP Hyper Text Transfer Protocol
NF Network Function
OTT Over The Top
PCF Policy Control Function
PDU Packet Data Unit
PLMN Public Land Mobile Network
SMF Session Management Function
UDM Unified Data Management
UDSF Unstructured Data Storage Function
UE User Equipment.

URI Uniform Resource Identifier.

1.-19. (canceled)

20. A method performed by a computer-implemented apparatus configured to implement a first network function, the method comprising:
transmitting, from the first network function, to a second network function, a first message including a first parameter indicating no-redundancy to indicate that a first context is exclusively bound to a specific Network Function (NF) service instance within the first network function; and
wherein the specific NF service instance is identified in a binding indication included in the first message.

21. The method according to claim 20, wherein the first message further includes a second parameter indicating a validation timer, and the validation timer indicates the validation period of the no-redundancy.

22. The method according to claim 21, wherein the validation timer is included in the binding indication or another Hyper Text Transfer Protocol (HTTP) header.

23. The method according to claim 20, wherein the first network function is an NF service producer, and the second network function is a NF service consumer;
wherein the first context is a resource context; and
wherein the first message is a response message or a notification message.

24. The method according to claim 20, wherein the first network function is a NF service consumer, and the second network function is a NF service producer;
wherein the first context is a session context or a resource context; and
wherein the first message is a request message or a subscription message.

25. The method according to claim 20,
wherein the first network function acts as home Session Management Function (SMF) for a Home-Routed Packet Data Unit (PDU) session, and the respective visit SMF for the Home-Routed PDU session does not support redundancy;
wherein the first network function is taken out of a set of NFs, due to service software upgrade, downgrade, or maintenance; or
wherein the first network function temporarily loses a connection towards an Unstructured Data Storage Function (UDSF), which is shared by a set of NFs.

26. The method according to claim 20, further comprising:
receiving, from the second network function, a second message including a third parameter indicating no-redundancy to indicate that a second context is exclusively bound to a specific NF service instance within the second network function; and
deleting the second context if the second network function is not available.

27. A method performed by a computer-implemented apparatus configured to implement a second network function, the method comprising:
receiving, at the second network function, from a first network function, a first message including a first parameter indicating no-redundancy to indicate that a first context is exclusively bound to a specific Network Function (NF) service instance within the first network function;
wherein the specific NF service instance is identified in a binding indication included in the first message.

28. The method according to claim 27, wherein the first message further includes a second parameter indicating a validation timer, and the validation timer indicates the validation period of no-redundancy.

29. The method according to claim 27, further comprising deleting the first context if the first network function is not available.

30. The method according to claim 28, further comprising deleting the first context if the first network function is not available when the validation timer indicates the no-redundancy is within the validation period.

31. The method according to claim 28, wherein the validation timer is included in the binding indication or another Hyper Text Transfer Protocol (HTTP) header.

32. The method according to claim 27, wherein the first network function is a NF service producer, and the second network function is a NF service consumer;
wherein the first context is a resource context; and
wherein the first message is a response message or a notification message.

33. The method according to claim 27, wherein the first network function is a NF service consumer, and the second network function is a NF service producer;
wherein the first context is a session context or a resource context; and
wherein the first message is a request message or a subscription message.

34. The method according to claim 27,
wherein the first network function acts as home Session Management Function (SMF) for a Home-Routed Packet Data Unit (PDU) session, and the respective visit SMF for the Home-Routed PDU session does not support redundancy;
wherein the first network function is taken out of a set of NFs, due to service software upgrade, downgrade, or maintenance; or
wherein the first network function temporarily loses a connection towards an Unstructured Data Storage Function (UDSF), which is shared by a set of NFs.

35. A computer-implemented apparatus configured to implement a first network function, the computer-implemented apparatus comprising:
at least one processor; and
a non-transitory computer readable medium coupled to the at least one processor, the non-transitory computer readable medium contains instructions executable by the at least one processor, whereby the at least one processor is configured to:
transmit, to a second network function, a first message including a first parameter indicating no-redundancy to indicate that a first context is exclusively bound to a specific Network Function (NF) service instance within the first network function; and
wherein the specific NF service instance is identified in a binding indication included in the first message.

36. The computer-implemented apparatus according to claim 35, wherein the first message further includes a second parameter indicating a validation timer, and the validation timer indicates the validation period of the no-redundancy.

37. The computer-implemented apparatus according to claim 36, wherein the validation timer is included in the binding indication or another Hyper Text Transfer Protocol (HTTP) header.

38. The computer-implemented apparatus according to claim 35, wherein the first network function is an NF service producer, and the second network function is a NF service consumer;
wherein the first context is a resource context; and
wherein the first message is a response message or a notification message.

39. The computer-implemented apparatus according to claim 35, wherein the first network function is a NF service consumer, and the second network function is a NF service producer;
wherein the first context is a session context or a resource context; and
wherein the first message is a request message or a subscription message.
